(19) United States
(12) Patent Application Publication
(10) Pub. No.: US 2024/0413633 A1
(43) Pub. Date: Dec. 12, 2024

(54) Pre-Charge Voltage Balancer

(71) Applicant: Smartville, Inc., Carlsbad, CA (US)

(72) Inventors: Willam von Novak, Carlsbad, CA (US); Antoni Tong, Carlsbad, CA (US)

(21) Appl. No.: 18/736,446

(22) Filed: Jun. 6, 2024

Related U.S. Application Data
(60) Provisional application No. 63/471,459, filed on Jun. 6, 2023.

(51) Int. Cl. H02J 1/10; H01M 50/512

(52) U.S. Cl. CPC H02J 1/10; H01M 50/512

(57) ABSTRACT

A resistive current limiting system for paralleling large high voltage batteries, the system comprising a plurality of switched resistors and at least one controller, wherein the plurality of switched resistors are driven by the at least one controller to maintain current and heat below pre-set limits. The system allows a connection between batteries to rapidly occur in a manner that does not exceed pre-set current limits of both the high voltage batteries being connected and existing batteries within the system.

### RELATED APPLICATIONS

This application claims the benefit of priority from U.S. Provisional Patent Application No. 63/471,459 filed Jun. 6, 2023.

### FIELD OF THE INVENTION

This application relates generally to the field of batteries and, specifically, for applications and methods of balancing individual batteries within larger battery systems by utilizing current-limiting, pre-charge circuits.

### BACKGROUND OF THE INVENTION

Second life EV batteries are a critical source of battery storage for large scale battery energy storage systems (BESS). Within five years, it is predicted that used electric vehicle (EV) batteries alone will be able to provide 100% of our grid energy storage needs, without using any additional raw materials. This will also postpone the need for recycling of these batteries by years, allowing recycling facilities more time to ramp up.

To enable this conversion to occur, large parallel arrays of EV batteries must be connected to a common bus, so their storage capacity can be scaled up easily in order to meet the needs of utility-scale systems. However, connecting large numbers of EV batteries together in parallel is challenging when all the batteries are not at the same state of charge, same state of health and/or same voltage.

The state of the art is found lacking in viable options to connect large numbers of EV batteries in parallel and to a common bus, without experiencing the known disadvantages associated with connecting many batteries at different charge states and different voltages.

The present invention describes several ways to make it easier to connect EV batteries to such a bus, including through switched-resistor current limiters, active resistor current limiters and switchmode current limiters.

### SUMMARY OF THE INVENTION

The present invention provides a resistive current limiting system for paralleling large high voltage batteries, the system comprising a plurality of switched resistors and at least one controller, wherein the plurality of switched resistors are driven by the at least one controller to maintain current and heat below pre-set limits. Preferably, the large high voltage batteries have different states of charge. Alternatively, the large high voltage batteries have different voltages relative to one another. Preferably, the large high voltage batteries are from used electric vehicles. Most preferably, the system allows a connection between batteries to rapidly occur in a manner that does not exceed pre-set current limits of both the high voltage batteries being connected and existing batteries within the system. Preferably, instances of this invention can limit current in one or more batteries even during normal operation.

In another aspect, the present invention provides a linear current limiting system for paralleling high voltage batteries comprising at least two linear pass elements, wherein the at least two linear pass elements are positioned to limit current in both directions. Preferably, the two linear pass elements are metal oxide semiconductor field-effect transistors connected in a common source, back-to-back configuration. Most preferably, the system further comprises a gate bias resistor. Most preferably, the system further comprises one or more control circuits that provide settings for a maximum temperature and a maximum current within the system.

In yet another aspect, the present invention provides for a switchmode current limiting system for paralleling high voltage batteries, the system comprising at least on inductor, at least two main switches and at least two rectifiers. Preferably, the system allows for current to be limited in both directions regardless of voltage differences between batteries connected to the system.

Optionally, the system allows for both buck and boost operation of the switchmode converter to manage both voltage and current in the attached battery.

### BRIEF DESCRIPTION OF THE DRAWINGS

The novel features of the present invention are set forth herein embodied in the form of the claims of the invention. Features and advantages of the present invention may be best understood by reference to the following detailed description of the invention, setting forth illustrative embodiments and preferred features of the invention, as well as the accompanying drawings, of which:

FIG. 1 shows a standard EV pre-charge circuit known in the art.

FIG. 2 shows proposed circuit using existing pre-charge resister for balancing of multiple batteries.

FIG. 3 shows a schematic of additional resistors added as a resistor ladder to a pre-charge circuit.

FIG. 4 shows an example of a resistor ladder external to the battery.

FIG. 5 shows a linear pre-charge current limiter system using two metal oxide semiconductor field-effect transistors (MOSFETs) positioned in back-to-back fashion.

FIG. 6 shows a standard 4-switch buck-boost system.

FIG. 7 shows a buck converter mode system used as a current limiter.

FIG. 8 also shows a buck converter mode system used as a current limiter.

FIG. 9 shows a preferred embodiment of a 4-switch buck boost system used as a current limiter.

### DETAILED DESCRIPTION OF THE INVENTION

Described herein are methods, devices and systems specifically configured to increase the capacity of a battery system in a simple and efficient manner. One way to enlarge the capacity is to run many smaller batteries in parallel. These smaller batteries could be single cell, or multi-cell batteries, or the batteries could be 1S batteries (only one cell, either by itself or paralleled) or nS batteries (where n batteries are placed in series).

Paralleling cells is relatively straightforward. However, if the paralleled cells are at different states of charge, this can be problematic. For example, if battery A is charged to 10%, its voltage might be 330 volts. If battery B is charged to 90%, its voltage might be 390 volts. If these batteries are paralleled without accounting for their different states of charge, extremely high levels of current might flow from the 90% battery to the 10% battery. This could overheat wiring, cause circuit protection devices (fuses and circuit breakers) to blow or could even cause damage to the batteries themselves due to overcurrent discharge or charge.

When batteries are made, new cells, which are all at nearly identical voltages and states of charge, are interconnected (both in series and parallel) to provide the desired energy storage, as well as voltage/current ranges. Accordingly, the problematic issues raised above are generally avoided when new cells, or new packs, are used.

However, there are circumstances where older batteries of varying states of charge must be paralleled, including but not limited to:
(1) an electric bicycle that allows more than one battery to be attached, in which case there is no control over each individual battery's state of charge or voltage;
(2) an energy storage system where used EV batteries are deployed, resulting in different batteries being used at different times, with different states of charge/health, and even different voltages; and
(3) a larger parallel battery charging system, wherein a single charger provides charge to the large number of portable or removable batteries from the system, each with potentially different states of charge.

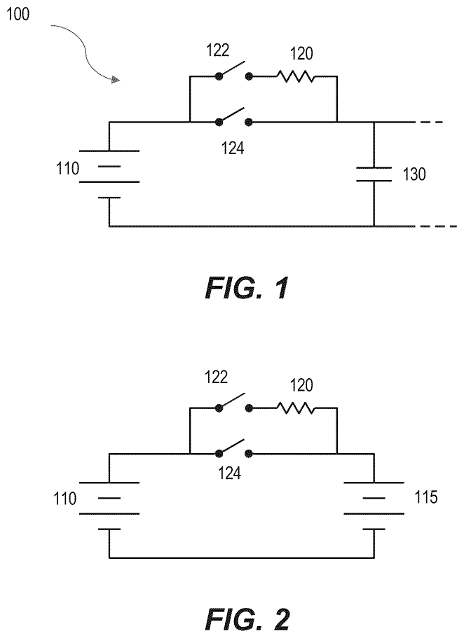

FIG. 1 shows an exemplary battery connection system known in the prior art. Standard pre-charge circuit 100 is for primary battery 110. Main switch 124 provides power to the loads (not shown on the far right of FIG. 1). Also provided is a relay connecting primary battery 110 to an output through pre-charge switch 122, resistor 120 and capacitor 130. This structure is preferred, since most loads include some filtering and/or local storage capacitance, resulting in drawing large amounts of current if the main contactor was in the closed position when the capacitor was at zero volts (which would be the case upon the starting of an EV motor). Such large amounts of current could potentially damage the main contactor, damage the battery or blow fuses or circuit breakers, depending on the size of capacitor 130 and the internal resistance of battery 110.

In order to avoid this result, pre-charge switch 122 is first closed in order to allow capacitor 130 to charge through resistor 120. This results in current being limited to V/R. The value (V) and power rating (R) of resistor 120 can be adjusted to ensure that several advantageous events occur, namely, that current flow is restricted, capacitor 130 is charged in a shorter amount of time and resistor 120 is not overheated (though overheating is generally not an issue, since the current flows for only an abbreviated amount of time).

There are several proposed solutions to allow paralleling of battery packs (or multiple batteries) that are of differing voltage and/or distinct states of charge. One proposed option is to utilize the circuit described at FIG. 1, but with more than one battery involved. In such an embodiment, shown at FIG. 2, when pre-charge switch 122 closes, primary battery 110 and secondary battery 115 are connected through resistor 120. This limits the current that can potentially flow between the batteries and, therefore, protects the wiring.

However, the embodiment shown at FIG. 2 can be problematic. The amount of charge (measured in coulombs or amp-seconds) needed to charge a capacitor is very low. Thus, while the peak current may be very high, the total heating of the resistor will be small. If the resistor is used to equalize to another battery, the required charge could be very large, resulting in a substantial risk of overheating the pre-charge resistor. Furthermore, the ideal resistor value will very much depend on the voltage difference between primary battery 110 and secondary battery 115. This will be difficult to select a pre-charge resistor that will work well for both pre-charging capacitors in the system and equalizing batteries that could potentially span a wide range of voltages.

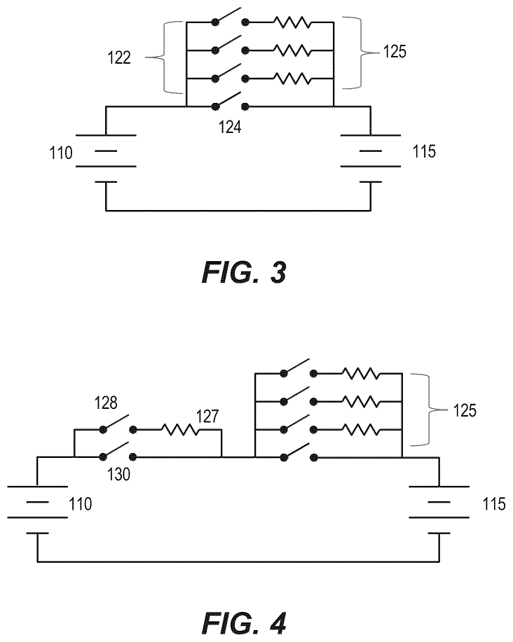

In a preferred embodiment, the present invention provides for a solution to the previously described limitations in the state of the art. FIG. 3 describes one solution, wherein additional resistors 125 can be added to pre-charge circuit 100, which allows selection of a more precise resistance that quickly balances the two batteries (110 and 115) without overheating the resistor or compromising the wiring. First battery 110 and second battery 115 are connected via additional switched resistors 125, with each having individual pre-charge switches 122 allowing the system to calculate voltage differences between the two batteries in order to choose a resistance that avoids overheating while simultaneously ensuring the maximum system current is not exceeded and minimizing the time required to match the battery voltages and allow final connection via the main switch 124.

In an alternative, preferred embodiment, the present invention provides for a pre-charge resistor to be used with additional switched resistors 125 from the system described at FIG. 3. In this further embodiment, however, additional switched resistors 125 are arranged in a stacked or ladder configuration outside the battery and separate from the battery's existing internal switches. FIG. 4 shows an exemplary configuration of this stacked or ladder resistor configuration. As shown at FIG. 4, internal main switch 130, internal pre-charge switch 128 and pre-charge resistor 127 are inside the battery and inaccessible externally. Preferably, as shown in FIG. 4, this configuration results in a resistor ladder assembly wherein pre-charge resistor 127 is used together with additional switched resistors 125.

Preferably, if resistor values are chosen as powers of two (ie. 1×, 2×, 4×, 8×, etc.) then a resistance may be chosen that optimizes equalization time, such as maximizing current while not exceeding current limits and, by extension, not exceeding resistor thermal values.

### Examples

### I. Performance Testing of Switched Resistors

Optionally, the present invention further provides for a multi-switched resistor system. Preferably, the multi-switched resistor system is a 4-switched resistor system. Table 1 below provides a performance comparison between a single resistor balancer (A) and a 4-resistor balancer system (B). Vdiff represents the differences in voltage between a new battery and an existing battery (or an existing battery system). Individual resistors are listed along the top row, with a range from 1 to 8 ohms. The columns comprising the Rn? values (R1?, R2?, etc.) contain a “1” if the resistor switch is on (in a closed position), and a “0” if the resistor is off (in an open position). The power dissipation of each resistor is calculated, along with the total current flowing between the new battery and the rest of the system.

TABLE 1
Measuring performance of resistor balancer

| | | | | |
|---|---|---|---|---|
| R1 | 1 | Increment | 2 | Power limit 1000W |
| R2 | 2 | | | Current limit 10A |
| R3 | 4 | | | |
| R4 | 8 | | | |

| | | | | | | | | | | | |
|---|---|---|---|---|---|---|---|---|---|---|---|
| Vdiff | R1? | R2? | R3? | R4? | P_{R1} | P_{R2} | P_{R3} | P_{R4} | P_{TOT} | R_{TOT} | Current |

(A) Single resistor balancer performance:

| | | | | | | | | | | | |
|---|---|---|---|---|---|---|---|---|---|---|---|
| 0 | 0 | 0 | 0 | 0 | 0.0 | 0.0 | 0.0 | 0.0 | 0.0 | NONE | NONE |
| 2 | 0 | 0 | 0 | 1 | 0.0 | 0.0 | 0.0 | 0.5 | 0.5 | 8.0 | 0.25 |
| 4 | 0 | 0 | 0 | 1 | 0.0 | 0.0 | 0.0 | 2.0 | 2.0 | 8.0 | 0.5 |
| 6 | 0 | 0 | 0 | 1 | 0.0 | 0.0 | 0.0 | 4.5 | 4.5 | 8.0 | 0.75 |
| 8 | 0 | 0 | 0 | 1 | 0.0 | 0.0 | 0.0 | 8.0 | 8.0 | 8.0 | 1 |
| 10 | 0 | 0 | 0 | 1 | 0.0 | 0.0 | 0.0 | 12.5 | 12.5 | 8.0 | 1.25 |
| 12 | 0 | 0 | 0 | 1 | 0.0 | 0.0 | 0.0 | 18.0 | 18.0 | 8.0 | 1.5 |
| 14 | 0 | 0 | 0 | 1 | 0.0 | 0.0 | 0.0 | 24.5 | 24.5 | 8.0 | 1.75 |
| 16 | 0 | 0 | 0 | 1 | 0.0 | 0.0 | 0.0 | 32.0 | 32.0 | 8.0 | 2 |
| 18 | 0 | 0 | 0 | 1 | 0.0 | 0.0 | 0.0 | 40.5 | 40.5 | 8.0 | 2.25 |
| 20 | 0 | 0 | 0 | 1 | 0.0 | 0.0 | 0.0 | 50.0 | 50.0 | 8.0 | 2.5 |
| 22 | 0 | 0 | 0 | 1 | 0.0 | 0.0 | 0.0 | 60.5 | 60.5 | 8.0 | 2.75 |
| 24 | 0 | 0 | 0 | 1 | 0.0 | 0.0 | 0.0 | 72.0 | 72.0 | 8.0 | 3 |
| 26 | 0 | 0 | 0 | 1 | 0.0 | 0.0 | 0.0 | 84.5 | 84.5 | 8.0 | 3.25 |
| 28 | 0 | 0 | 0 | 1 | 0.0 | 0.0 | 0.0 | 98.0 | 98.0 | 8.0 | 3.5 |
| 30 | 0 | 0 | 0 | 1 | 0.0 | 0.0 | 0.0 | 112.5 | 112.5 | 8.0 | 3.75 |
| 32 | 0 | 0 | 0 | 1 | 0.0 | 0.0 | 0.0 | 128.0 | 128.0 | 8.0 | 4 |
| 34 | 0 | 0 | 0 | 1 | 0.0 | 0.0 | 0.0 | 144.5 | 144.5 | 8.0 | 4.25 |
| 36 | 0 | 0 | 0 | 1 | 0.0 | 0.0 | 0.0 | 162.0 | 162.0 | 8.0 | 4.5 |
| 38 | 0 | 0 | 0 | 1 | 0.0 | 0.0 | 0.0 | 180.5 | 180.5 | 8.0 | 4.75 |
| 40 | 0 | 0 | 0 | 1 | 0.0 | 0.0 | 0.0 | 200.0 | 200.0 | 8.0 | 5 |
| 42 | 0 | 0 | 0 | 1 | 0.0 | 0.0 | 0.0 | 220.5 | 220.5 | 8.0 | 5.25 |
| 44 | 0 | 0 | 0 | 1 | 0.0 | 0.0 | 0.0 | 242.0 | 242.0 | 8.0 | 5.5 |
| 46 | 0 | 0 | 0 | 1 | 0.0 | 0.0 | 0.0 | 264.5 | 264.5 | 8.0 | 5.75 |
| 48 | 0 | 0 | 0 | 1 | 0.0 | 0.0 | 0.0 | 288.0 | 288.0 | 8.0 | 6 |
| 50 | 0 | 0 | 0 | 1 | 0.0 | 0.0 | 0.0 | 312.5 | 312.5 | 8.0 | 6.25 |
| 52 | 0 | 0 | 0 | 1 | 0.0 | 0.0 | 0.0 | 338.0 | 338.0 | 8.0 | 6.5 |
| 54 | 0 | 0 | 0 | 1 | 0.0 | 0.0 | 0.0 | 364.5 | 364.5 | 8.0 | 6.75 |
| 56 | 0 | 0 | 0 | 1 | 0.0 | 0.0 | 0.0 | 392.0 | 392.0 | 8.0 | 7 |
| 58 | 0 | 0 | 0 | 1 | 0.0 | 0.0 | 0.0 | 420.5 | 420.5 | 8.0 | 7.25 |
| 60 | 0 | 0 | 0 | 1 | 0.0 | 0.0 | 0.0 | 450.0 | 450.0 | 8.0 | 7.5 |
| 62 | 0 | 0 | 0 | 1 | 0.0 | 0.0 | 0.0 | 480.5 | 480.5 | 8.0 | 7.75 |
| 64 | 0 | 0 | 0 | 1 | 0.0 | 0.0 | 0.0 | 512.0 | 512.0 | 8.0 | 8 |
| 66 | 0 | 0 | 0 | 1 | 0.0 | 0.0 | 0.0 | 544.5 | 544.5 | 8.0 | 8.25 |
| 68 | 0 | 0 | 0 | 1 | 0.0 | 0.0 | 0.0 | 578.0 | 578.0 | 8.0 | 8.5 |
| 70 | 0 | 0 | 0 | 1 | 0.0 | 0.0 | 0.0 | 612.5 | 612.5 | 8.0 | 8.75 |
| 72 | 0 | 0 | 0 | 1 | 0.0 | 0.0 | 0.0 | 648.0 | 648.0 | 8.0 | 9 |
| 74 | 0 | 0 | 0 | 1 | 0.0 | 0.0 | 0.0 | 684.5 | 684.5 | 8.0 | 9.25 |
| 76 | 0 | 0 | 0 | 1 | 0.0 | 0.0 | 0.0 | 722.0 | 722.0 | 8.0 | 9.5 |
| 78 | 0 | 0 | 0 | 1 | 0.0 | 0.0 | 0.0 | 760.5 | 760.5 | 8.0 | 9.75 |
| 80 | 0 | 0 | 0 | 1 | 0.0 | 0.0 | 0.0 | 800.0 | 800.0 | 8.0 | 10 |
| 82 | 0 | 0 | 0 | 0 | 0.0 | 0.0 | 0.0 | 0.0 | 0.0 | NONE | NONE |
| | | | | | | | | | | 0-80V Avg | 5.13 |
| | | | | | | | | | | 0-40V Avg | 2.63 |

(B) 4-resistor balancer performance:

| | | | | | | | | | | | |
|---|---|---|---|---|---|---|---|---|---|---|---|
| 0 | 0 | 0 | 0 | 0 | 0.0 | 0.0 | 0.0 | 0.0 | 0.0 | NONE | NONE |
| 2 | 1 | 1 | 1 | 1 | 4.0 | 2.0 | 1.0 | 0.5 | 7.5 | 0.5 | 3.75 |
| 4 | 1 | 1 | 1 | 1 | 16.0 | 8.0 | 4.0 | 2.0 | 30.0 | 0.5 | 7.5 |
| 6 | 1 | 1 | 0 | 1 | 36.0 | 18.0 | 0.0 | 4.5 | 58.5 | 0.6 | 9.75 |
| 8 | 1 | 0 | 1 | 0 | 64.0 | 0.0 | 16.0 | 0.0 | 80.0 | 0.8 | 10 |
| 10 | 0 | 1 | 1 | 1 | 0.0 | 50.0 | 25.0 | 12.5 | 87.5 | 1.1 | 8.75 |
| 12 | 0 | 1 | 1 | 0 | 0.0 | 72.0 | 36.0 | 0.0 | 108.0 | 1.3 | 9 |
| 14 | 0 | 1 | 0 | 1 | 0.0 | 98.0 | 0.0 | 24.5 | 122.5 | 1.6 | 8.75 |
| 16 | 0 | 1 | 0 | 1 | 0.0 | 128.0 | 0.0 | 32.0 | 160.0 | 1.6 | 10 |
| 18 | 0 | 1 | 0 | 0 | 0.0 | 162.0 | 0.0 | 0.0 | 162.0 | 2.0 | 9 |
| 20 | 0 | 1 | 0 | 0 | 0.0 | 200.0 | 0.0 | 0.0 | 200.0 | 2.0 | 10 |
| 22 | 0 | 0 | 1 | 1 | 0.0 | 0.0 | 121.0 | 60.5 | 181.5 | 2.7 | 8.25 |
| 24 | 0 | 0 | 1 | 1 | 0.0 | 0.0 | 144.0 | 72.0 | 216.0 | 2.7 | 9 |
| 26 | 0 | 0 | 1 | 1 | 0.0 | 0.0 | 169.0 | 84.5 | 253.5 | 2.7 | 9.75 |
| 28 | 0 | 0 | 1 | 0 | 0.0 | 0.0 | 196.0 | 0.0 | 196.0 | 4.0 | 7 |
| 30 | 0 | 0 | 1 | 0 | 0.0 | 0.0 | 225.0 | 0.0 | 225.0 | 4.0 | 7.5 |
| 32 | 0 | 0 | 1 | 0 | 0.0 | 0.0 | 256.0 | 0.0 | 256.0 | 4.0 | 8 |
| 34 | 0 | 0 | 1 | 0 | 0.0 | 0.0 | 289.0 | 0.0 | 289.0 | 4.0 | 8.5 |
| 36 | 0 | 0 | 1 | 0 | 0.0 | 0.0 | 324.0 | 0.0 | 324.0 | 4.0 | 9 |
| 38 | 0 | 0 | 1 | 0 | 0.0 | 0.0 | 361.0 | 0.0 | 361.0 | 4.0 | 9.5 |
| 40 | 0 | 0 | 1 | 0 | 0.0 | 0.0 | 400.0 | 0.0 | 400.0 | 4.0 | 10 |
| 42 | 0 | 0 | 0 | 1 | 0.0 | 0.0 | 0.0 | 220.5 | 220.5 | 8.0 | 5.25 |
| 44 | 0 | 0 | 0 | 1 | 0.0 | 0.0 | 0.0 | 242.0 | 242.0 | 8.0 | 5.5 |
| 46 | 0 | 0 | 0 | 1 | 0.0 | 0.0 | 0.0 | 264.5 | 264.5 | 8.0 | 5.75 |
| 48 | 0 | 0 | 0 | 1 | 0.0 | 0.0 | 0.0 | 288.0 | 288.0 | 8.0 | 6 |
| 50 | 0 | 0 | 0 | 1 | 0.0 | 0.0 | 0.0 | 312.5 | 312.5 | 8.0 | 6.25 |
| 52 | 0 | 0 | 0 | 1 | 0.0 | 0.0 | 0.0 | 338.0 | 338.0 | 8.0 | 6.5 |
| 54 | 0 | 0 | 0 | 1 | 0.0 | 0.0 | 0.0 | 364.5 | 364.5 | 8.0 | 6.75 |
| 56 | 0 | 0 | 0 | 1 | 0.0 | 0.0 | 0.0 | 392.0 | 392.0 | 8.0 | 7 |
| 58 | 0 | 0 | 0 | 1 | 0.0 | 0.0 | 0.0 | 420.5 | 420.5 | 8.0 | 7.25 |
| 60 | 0 | 0 | 0 | 1 | 0.0 | 0.0 | 0.0 | 450.0 | 450.0 | 8.0 | 7.5 |
| 62 | 0 | 0 | 0 | 1 | 0.0 | 0.0 | 0.0 | 480.5 | 480.5 | 8.0 | 7.75 |
| 64 | 0 | 0 | 0 | 1 | 0.0 | 0.0 | 0.0 | 512.0 | 512.0 | 8.0 | 8 |
| 66 | 0 | 0 | 0 | 1 | 0.0 | 0.0 | 0.0 | 544.5 | 544.5 | 8.0 | 8.25 |
| 68 | 0 | 0 | 0 | 1 | 0.0 | 0.0 | 0.0 | 578.0 | 578.0 | 8.0 | 8.5 |
| 70 | 0 | 0 | 0 | 1 | 0.0 | 0.0 | 0.0 | 612.5 | 612.5 | 8.0 | 8.75 |
| 72 | 0 | 0 | 0 | 1 | 0.0 | 0.0 | 0.0 | 648.0 | 648.0 | 8.0 | 9 |
| 74 | 0 | 0 | 0 | 1 | 0.0 | 0.0 | 0.0 | 684.5 | 684.5 | 8.0 | 9.25 |
| 76 | 0 | 0 | 0 | 1 | 0.0 | 0.0 | 0.0 | 722.0 | 722.0 | 8.0 | 9.5 |
| 78 | 0 | 0 | 0 | 1 | 0.0 | 0.0 | 0.0 | 760.5 | 760.5 | 8.0 | 9.75 |
| 80 | 0 | 0 | 0 | 1 | 0.0 | 0.0 | 0.0 | 800.0 | 800.0 | 8.0 | 10 |
| 82 | 0 | 0 | 0 | 0 | 0.0 | 0.0 | 0.0 | 0.0 | 0.0 | NONE | NONE |
| | | | | | | | | | | 80-0 Avg | 8.14 |
| | | | | | | | | | | 40-0 Avg | 8.65 |

At Table 1 (A), a single 8-ohm resistor is used. It is noted that, for the single resistor data at Table 1 (A), the average current for the 0-40 volt differential is 2.6 amps, while the average current for the 0-80 volt differential is 5.1 amps.

At Table 1 (B), four resistors are used to establish resistance such that the current approaches, but never exceeds, 10 amps. For this 4-resistor system, the average current for the 0-40 volt differential is 8.7 amps, while the average current for the 0-80 volt differential is 8.1 amps. This is a drastic and significant improvement in balancing current when compared to the single resistor system of Table 1 (A). Furthermore, this improved current results in faster balancing times and faster/more complete connections of a newly added battery (which is premised on the assumption that once the voltage difference falls under 2 volts, the main contactor can be closed and the resistors disconnected, after which point the new battery is fully and completely connected).

The data and results from the resistor systems shown at Table 1 assume 1000-watt resistors used within each system. If smaller resistors are deployed, a similar scheme may be utilized, so long as a temperature measurement system is incorporated to open the relay to any resistor to prevent overheating.

The system tested in Table 1 (B) shows how a multi-resistor scheme can protect the system from damage due to overloading. As shown in Table 1 (B), the resistors are switched in and of the system as the voltages begin to converge, which could lead to resistors being briefly overloaded. The system can then open the switch on that resistor if its maximum temperature (as measured by a temperature sensor) is exceeded. Since different value resistors experience different heating and power ratings per resistor, individual resistors may be selected in order to minimize space or cost.

### II. Active Resistance Control

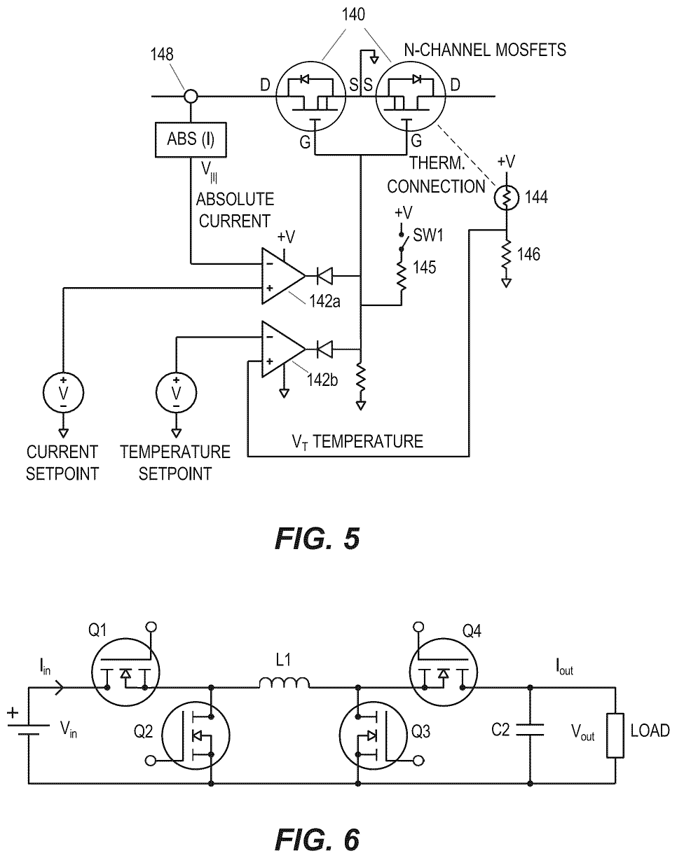

After testing multiple systems, it was determined that the ideal resistance balancer would be one that maintains a resistance that maximizes current and keeps it just under a preset maximum limit to prevent overheating of the resistor element. This preferred embodiment can be accomplished by using an active resistor, which can be implemented with metal oxide semiconductor field-effect transistors (MOSFETs) or similar switches. FIG. 5 describes this preferred embodiment, wherein the active resistor is implemented with two MOSFETs connected back-to-back in the common source configuration. In this configuration, two devices are needed, since MOSFETs contain internal junction diodes that allow current flow in one direction, resulting in two opposite devices being required in order to always be able to block current. This is a common configuration for solid state relays as well.

An exemplary embodiment reflecting the linear pre-charge current limiter as the active resistive element is shown at FIG. 5. Two source connected FETs 140 serve as the active element in this example. Each source connected FET 140 is positioned in a back-to-back fashion and comprises source S, drain D and gate G. Thermistor 144 is thermally connected to, and maintained at the same temperature as, the two source connected FETs 140. When switch SW1 is off, the gate potentials drop to ground, with no current flowing and the element is completely off. When switch SW1 is closed, then first resistor 145 (which has a lower value than second resistor 146) pulls the gates up well above their gate threshold voltages so both elements are potentially fully on.

At least two operational amplifiers (top op-amp 142a and bottom op-amp 142b), connected with diodes, are utilized to reduce the gate voltage. Preferably, either top op-amp 142a or bottom op-amp 142b can pull down the voltage, so either input can substantially decrease the gate voltage, thus increasing the resistance of the active element and limiting the current flowing through the pre-charge circuit. First resistor 145 and second resistor 146 are chosen such that the two source connected FETs 140 are fully on if neither the current nor the temperature limit operational amplifiers (142a or 142b) are active.

The setpoint voltage sources represent adjustable settings, which are preferably selected in order to limit maximum current (current setpoint) and temperature (temperature setpoint) to appropriately safe levels.

Absolute value element ABS takes a +/−input and takes only the absolute value of the input voltage, resulting in an output that is only in the positive range.

Thermistor 144 and second resistor 146 generate a voltage Vt that is proportional to temperature of FETs 140.

Preferably, top op-amp 142a is connected to current sensor 148. Absolute value element ABS is positioned after current sensor 148 so that current in either direction is reported identically. This is advantageous, since current in either direction must be limited to a safe level, regardless of the current's direction. This signal goes to the negative input of the operational amplifiers, while the positive input is driven by a voltage source that is set to a threshold.

For example, if current sensor 148 returns 1 volt when the current is at maximum, the current setpoint would also be set to 1 volt. As long as the positive voltage input exceeds the negative voltage input of the operational amplifiers, the operational amplifier's output will be as high as possible, which means the voltage of the gates are not pulled down. Once the current in the circuit exceeds the preset limit established by the current setpoint, the operational amplifier's output will be reduced, the gates will be pulled down and the resistance with increase. This is how the current is limited. Similarly, thermistor 144 is in thermal contact with two source connected FETs 140. As both FETs heat up, VT will rise. When VT exceeds the temperature setpoint voltage, then bottom op-amp 142b will pull the gates down and increase the resistance in the active element, resulting in a decrease in current and an eventual reduction of the active element temperature.

### III. Switchmode Current Control

The prior embodiments described in Examples I and II illustrate solutions using resistive methods in order to limit current. Such an approach dissipates excess power as heat, which can be extremely problematic from a thermal-management perspective. This is typically not an issue, since the balancing event occurs infrequently, after batteries have been disconnected from each other or a new battery is added. In some cases, however, the peak power required may be excessive and this will require a great deal of space in order to dissipate the heat.

In such instances, a switchmode approach is preferred and may be used to significantly reduce heat dissipation. It can also be used to partially isolate a battery from the remaining batteries in case such an individual battery must be treated differently than the rest of the batteries. For instance, this would be the case where a user decides to cycle a new battery in a different manner than an old battery in order to gradually bring both batteries to a similar state of health. To accomplish this, a four-switch buck-boost system is traditionally utilized with a different control scheme. A standard buck-boost system is shown at FIG. 6. Main switches Q1 and Q4 are used together with synchronous rectifier switches Q2 and Q3. This system can be configured to be a boost converter, or a buck converter, and can be set to operate in either direction.

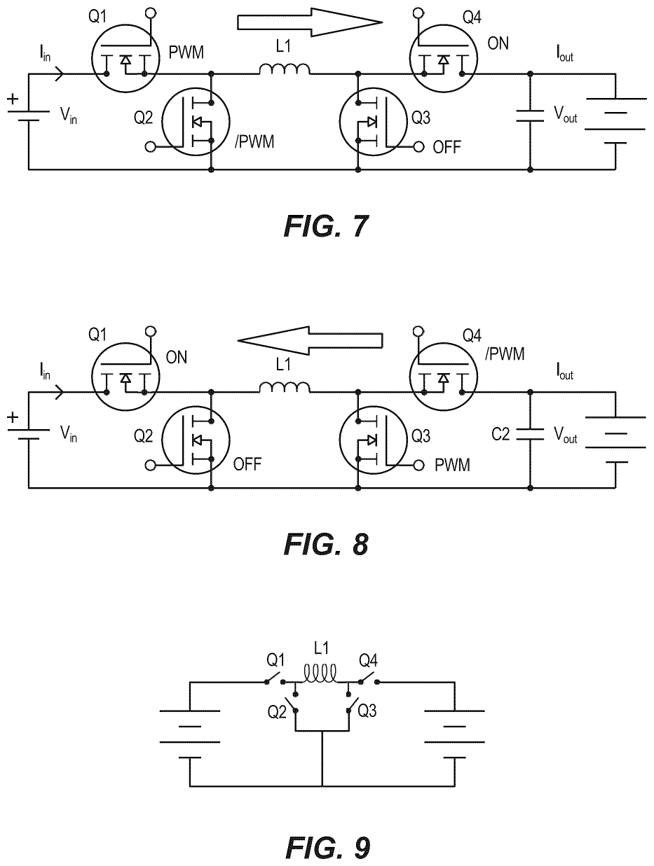

An example of a buck converter mode system is shown at FIG. 7. This shows operation when the left battery is higher in voltage than the right battery. In this embodiment, main switch Q4 is turned on, while synchronous rectifier switch Q3 is in the off position. A pulse width modulation (PWM) signal is applied to the other two switches (main switch Q1 and synchronous rectifier switch Q3). Main switch Q1 is turned on and off at a high frequency and its duty cycle is adjusted so the current (shown by the arrow) is maintained at a safe level. synchronous rectifier switch Q2 does the opposite of what main switch Q1 does. For instance, when main switch Q1 is on, synchronous rectifier switch Q2 is off, and vice versa.

FIG. 8 shows an opposite situation, where the left battery is lower in voltage than the right battery. This embodiment again shows buck converter mode operation, wherein main switch Q1 is permanently on and synchronous rectifier switch Q2 is permanently off. synchronous rectifier switch Q3 is turned on and off at high frequency and its duty cycle is adjusted so that the current (shown by the arrow) is maintained at a safe level. Main switch Q4 does the opposite of what synchronous rectifier switch Q3 does. For example, when synchronous rectifier switch Q3 is on, main switch Q4 is off, and vice versa.

Both modes (FIG. 7) and (FIG. 8) are symmetrical with each other, such that one system is a mirror image of the other. This enables current to be limited in both directions, regardless of the voltage difference between the batteries. Furthermore, instead of driving the switches in a manner known in the art to achieve a specific voltage at the output, this solution results in switches being driven to achieve a current below a specific limit. Additionally, both sides of the converter are connected to batteries rather than a source and load. This is shown in more detail at FIG. 9, which provides a schematic describing a 4-switch buck boost system used as a current limiter.

This 4-switch buck boost system, in normal operation, will only use buck mode. The direction will be chosen based on which side of the converter comprises the higher voltage. This side having the higher voltage will be driven by the PWM signal. Rather than setting the PWM duty cycle to maintain a given output voltage, the PWM duty cycle will be driven to maintain a specific current at the maximum limit. The PWM duty cycle will be increased until the current through the inductor reaches a preset limit, after which time the PWM will be held at that precise duty cycle.

Once the voltages of the two batteries become close enough to one another, the PWM duty cycle will reach 100%. At that point, both top switches (Q1 and Q4) will be hard on, both bottom switches (Q2 and Q3) will be hard off, and both batteries will be directly connected through inductor L1.

If a lower resistance connection is desired, then a separate switch is used to bypass the 4-switch buck-boost system. If a simpler control is preferred, the bottom switches can be replaced with diodes, which will obviate the need for a complementary PWM drive, but will reduce efficiently due to the forward drop of the diodes.

If maintaining a certain voltage is desired (where one battery is cycled more deeply than another, for example), the 4-switch converted can be used in both buck mode and boost mode. An example of this would be where one battery is deeply cycled from 300 volts to 400 volts, while another battery is cycled more gradually from 320 volts to 380 volts.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features. As used in this specification and in the appended claims, the singular forms include the plural forms. For example, the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

We claim:

1. A resistive current limiting system for paralleling high voltage batteries, the system comprising a plurality of switched resistors and at least one controller, wherein the plurality of switch resistors are driven by the at least one controller to maintain current and heat within the system below pre-set levels.

2. The system of claim 1, wherein the high voltage batteries have different states of charge relative to one another.

3. The system of claim 1, wherein the high voltage batteries have different voltages relative to one another.

4. The system of claim 1, wherein the high voltage batteries are from used electric vehicles.

5. The system of claim 1, wherein the system allows a connection between batteries to rapidly occur in a manner that does not exceed pre-set current limits of both the high voltage batteries being connected and existing batteries within the system.

6. The system of claim 1, wherein the system limits current in one or more of the high voltage batteries during operation.

7. A linear current limiting system for paralleling high voltage batteries, the system comprising at least two linear pass elements, wherein the at least two linear pass elements are positioned to limit current in both directions.

8. The system of claim 7, where the two linear pass elements are MOSFETs connected in a common-source, back-to-back configuration.

9. The system of claim 7, where the system further comprises a gate bias resistor.

10. The system of claim 7, wherein the system further comprises one or more control circuits that provide settings for a maximum temperature and a maximum current within the system.

11. A switchmode current limiting system for paralleling high voltage batteries, the system comprising at least an inductor, at least two main switches and at least two rectifiers.

12. The system of claim 11, wherein the system allows for current to be limited in both directions regardless of voltage differences between batteries connected to the system.

13. The system of claim 11, wherein the system allows for both buck and boost operation of the switchmode converter to manage both voltage and current in the attached battery.
